(19) United States
(12) Patent Application Publication
(10) Pub. No.: US 2012/0005210 A1
(43) Pub. Date: Jan. 5, 2012

(54) Method of Structuring a Database of Objects

(75) Inventors: Cédric Tavernier, Dubal (FR); Jean-Luc Rogier, Colombes (FR)

(73) Assignee: THALES, Neuilly-sur-Seine (FR)

(21) Appl. No.: 13/130,430

(22) PCT Filed: Nov. 18, 2009
(86) PCT No.: PCT/EP09/65422

§ 371 Date: Jul. 19, 2011

(30) Foreign Application Priority Data
Nov. 21, 2008 (FR) 0806551

(51) Int. Cl. G06F 17/30

(52) U.S. Cl. 707/737; 707/E17.046

(57) ABSTRACT

A method of structuring a database of objects, the objects each comprising one or more attributes, the attributes being ordered, the method being executed by at least one computer processor connected to a memory, the method classifying in memory the objects in a structure composed of a list CL of sets of formal concepts Cᵢ, includes at least the following steps: create several groups of attributes S_{Ai}; for each of said groups S_{Ai}, construct a closed set Pᵢ composed of all the attributes common to the objects comprising at least the attributes of said group S_{Ai}; determine the list CL of formal concepts Cᵢ ordered in the lexicographic order, by successively determining the formal concepts in order of increasing intent, the intent F of a formal concept Cᵢ being formed by a set of closed sets Pᵢ.

The present invention relates to a method for structuring a database of objects. The invention is notably applicable to the indexing and to the merging of data.

With the explosion of the volume of data present on computer networks and in databases, there is an evermore pressing need for indexing and for classification. For example, the study of a botanical taxonomy or the management of objects stored in a geographical information system requires classification or categorization of the data in order to reduce their memory storage requirements and/or to provide the fastest possible topic-related access to the data.

A known method for data classification and analysis is provided by formal concept analysis, often denoted by the acronym FCA. A formal context K=(G,M,I) comprises a set of objects G, a set of attributes M, and a binary relationship I over G×M which indicates, for each object, the attributes that it possesses. For a given relationship I, the two following functions can be defined:
f, which associates with any sub-set of objects B the set of attributes common to all the objects,

f(B)=B^{↑}={mεM|uIm for all uεB};
g, which associates with any sub-set of objects A the set of objects which possess at least all these attributes,

g(A)=A^{↓}={uεG|uIm for all mεA}.

Each of these functions forms a Galois connection between the parts of G and the parts of M. The composition of these functions f and g thus creates a closure system for G on M.

Also, a formal concept (X,Y), more simply referred to as concept hereinbelow, is defined by two sub-sets X and Y such that:
X is a sub-set of objects which is the extension of the concept (X,Y);
Y is a sub-set of attributes which is the intent of the concept (X,Y);
f(X)=Y;
g(Y)=X.
   X is closed for g∘f, and Y is closed for f∘g. The composition g∘f defines a closure operator on the set of attributes and f∘g a closure operator on the set of objects. The closure operator on the set of attributes is henceforth denoted as λ (λ=g∘f).

A system of implications is also defined as a set of implications Yᵢ→Yₖ between a first sub-set of attributes Yᵢ and a second sub-set of attributes Yₖ, such an implication meaning that if an object comprises all the attributes of the sub-set Yᵢ, then this object also comprises all the attributes of the sub-set Yₖ. A base of implications is a minimum set of implications that allows the set of implications to be derived for the system.

In “FCA” theory, there is an equivalence between:
the closure operator λ defined over the sub-sets of attributes (the parts of M),
a Galois lattice of concepts,
the binary relationship I,
a base of implications over the sub-sets of attributes.

For more in-depth information on the prior art, the following publications could notably be consulted:
Zenou et al., “Characterization of image sets: The Galois lattice approach”, RFIA 2004;
Valtchev et al., “A fast algorithm for building the Hasse diagram of a Galois lattice”, Proceedings of the Colloquium LaCIM 2000.

Generally speaking, in the majority of applications, the Galois lattice is constructed from the closure operator, in order to be able to index the attributes and the objects in the lattice. The closure operator is typically obtained, either starting from the binary relationship I, or starting from a system of implications. Once the lattice has been obtained, it is also possible to determine a base of implications producing the same closure operator, notably when the latter has been obtained from the binary relationship between the attributes and the objects.

The existing FCA methods of classification generally aim to produce a lattice comprising the whole of the formal concepts, in other words, all the closed sets with respect to the closure operator, then to order it according to the partial order relationship of the lattice. Subsequently, in order to represent the lattice, a Hasse diagram is generally constructed, this diagram representing the transitive reduction of the order relationship of the lattice. However, these methods become unusable when the taxonomy studied comprises several tens of attributes or more, because the processing complexity of said methods grows with the number of combinations depending on the size of the input data to be processed (exponentially in the worst case). Indeed, the generation of all of the formal concepts can turn out to be very costly, both in memory capacity and in processing power, because, in the worst case scenario, the number of formal concepts is equal to the number of partitions of the set of attributes, in other words 2 to the power the number of attributes. However, in many practical situations, it is desirable to establish a Galois lattice that contains only a well-identified fraction of formal concepts considered useful for a particular application, while at the same time preserving the structure of lattice.

A second drawback of the existing methods is that they do not take into account the incompatibilities between attributes. For example, when the goal is to classify vehicles, it is already known that a vehicle comprising the attribute “caterpillar traction vehicle” cannot comprise the attribute “tourism vehicle”. So, specifying this type of incompatibility can facilitate the classification of the objects.

One aim of the invention is to reduce the memory usage and/or the processing complexity required for classifying objects in a memory structure organized as a Galois lattice, said lattice comprising a minimum number of formal concepts {objects, attributes}, the set of said concepts forming a fraction of all the formal concepts that may be deduced from the set of attributes in question for classifying the objects. For this purpose, one subject of the invention is a method of structuring a database of objects each comprising one or more attributes, the attributes being ordered, the method classifying the objects in memory in a structure composed of an ordered list CL of useful formal concepts Cᵢ, the method being characterized in that it comprises at least the following steps:
create several groups of attributes S_{Ai}, each of said groups bringing together several attributes chosen from amongst the existing attributes;
for each of said groups S_{Ai}, construct a closed set Pᵢ resulting from the application of a closure operator on S_{Ai};
starting from the previously created closed sets of attributes Pᵢ determine the list CL of useful formal concepts Cᵢ ordered in the lexicographic order, which order is obtained based on their intent, the intent F of a formal concept Cᵢ being formed by a set of closed sets Pᵢ.

This method allows the number of formal concepts to be calculated for constructing the list CL to be reduced, and the processing time and the memory storage space to be reduced, for the construction of this list and for the later calculations.

Thus, for a performance identical to that obtained with conventional methods, the processing and memory hardware resources can be reduced.

In contrast to a conventional method that produces a list of formal concepts Cᵢ with each of said concepts Cᵢ comprising, on the one hand, an extension composed of objects all having at least all the attributes of a set Iᵢ, said formal concept Cᵢ comprising, on the other hand, an intent only composed of the attributes of the set Iᵢ, said attributes being the attributes common to all said objects, the formal concepts produced by the method according to the invention comprise an intent composed of closed sets of attributes Pᵢ, the objects of the extension of the concept having at least all the attributes included in these closed sets Pᵢ.

The groups of attributes S_{Ai} are formed in such a manner that, for each object that the user wishes to classify, the set of its attributes may be described either by a group S_{Ai}, or by a union of groups S_{Ai}.

According to one embodiment of the method according to the invention, the method classifies the objects in a memory structure forming a Galois lattice, the method constructing a list Border of formal concepts each corresponding to a node of the lattice, the method being characterized in that it associates with the concept Cᵢ of a node of the lattice a list upperCover(Ci) of formal concepts whose intent, composed of closed sets of attributes Pᵢ, is included in the intent of the concept Cᵢ. The lattice can thus be represented in the form of a Hasse diagram.

According to one embodiment of the method according to the invention, one or more data values specifying implications of attributes are supplied to the input of the method, each attribute implication data value comprising a first set of attributes and a second set of attributes, the presence of the attributes of the first set in an object implying the presence of the attributes of the second set in said object, the implication data being used to determine the closed sets of attributes Pᵢ starting from the groups of attributes S_{Ai}, at least one implication data value comprising, in the second set of attributes, a distinctive attribute a^{⊥}, said attribute being necessarily absent from all the objects, in such a manner that said implication data value specifies attributes that are incompatible with one another, the presence of an attribute of the first set in an object implying the simultaneous absence of all the other attributes of this first set in said object. The introduction of this distinctive attribute a^{⊥} facilitates, accelerates and improves the construction of the lattice by enhancing the system of implications allowing the closure of the groups of attributes S_{Ai} to be determined.

Another subject of the invention is an operational information system implementing the method, such as described hereinabove, for classifying tactical entities, notably to enable fast access to said entities and to facilitate the merging of several entities stored in the database when these entities correspond to the same real object.

The method according to the invention may also, for example, be implemented in a geographical information system for classifying objects geo-referenced by said system.

More generally, the method of structuring a database according to the invention can be used in all the fields where the aim is to classify individuals according to their characteristics. For example, in the case of biochemistry, molecules or compounds may be classified according to the molecular fragments. In the case of botany, species may be classified according to their characteristics.

Other features will become apparent upon reading the following detailed description presented by way of non-limiting example and making reference to the appended drawings, which show:

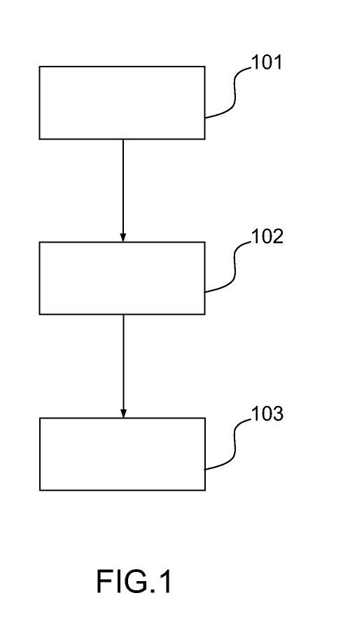

FIG. 1, the steps of a method according to the invention,

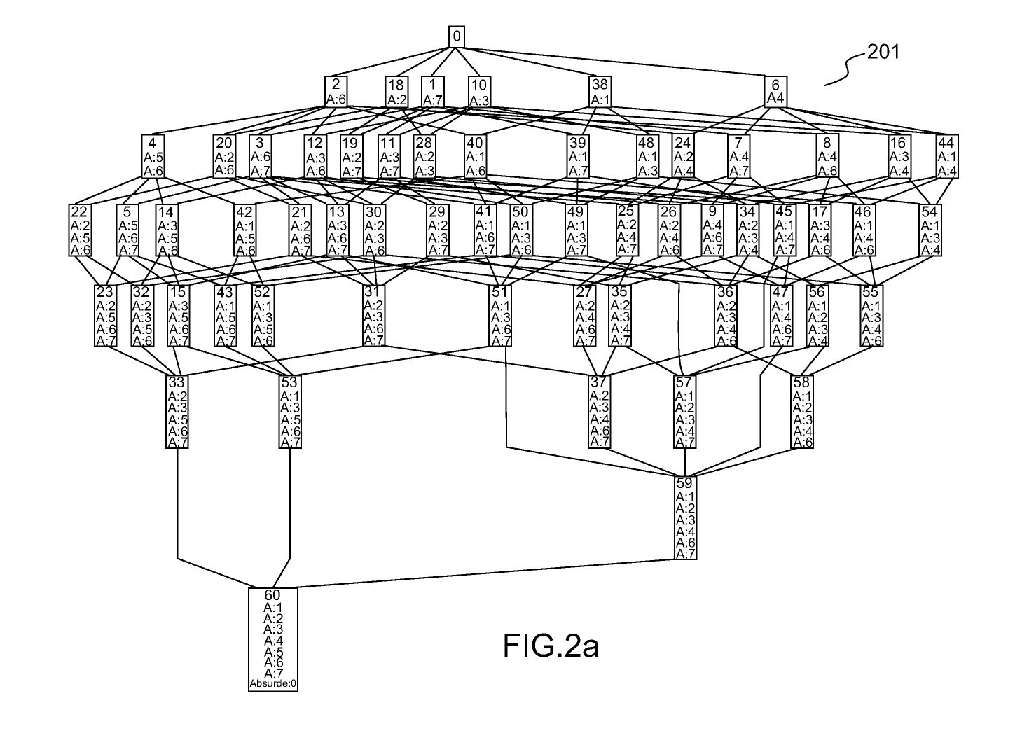

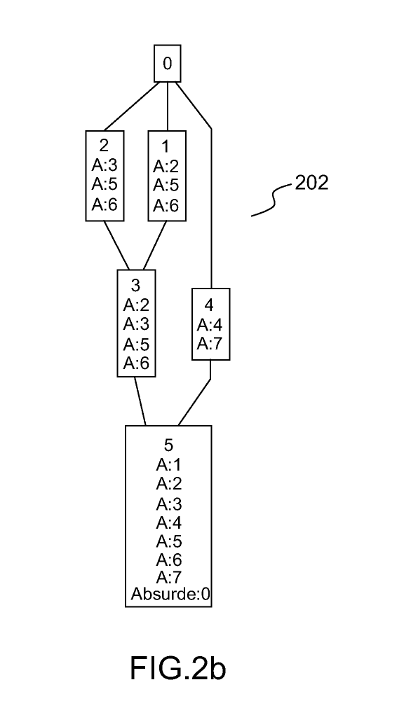

FIGS. 2a and 2b, a lattice obtained with a conventional method and with a method according to the invention, respectively.

In order to classify the objects of a set O, it is desirable to construct a Galois lattice of minimum size from a set of attributes A, the objects of O comprising attributes belonging to the set A.

In contrast to the conventional methods, the method according to the invention only takes a fraction of the parts of A into account. The reason for this is that, for many applications, the combinations of attributes are not all relevant, because certain types of objects can be ignored by the application. So, it is unnecessarily costly to consider all of the formal concepts that it is possible to form from the attributes received at the input.

Accordingly, as illustrated in the figure, during a first step 101 of the method according to the invention, a list S_{A} is created comprising a fraction of the parts of A. These parts of A are formed prior to the execution of the steps for construction of the lattice, depending on the needs of the user with respect to the application. The list S_{A} therefore comprises groups S_{A1}, . . . , S_{Am}, each of these groups S_{Ai} 1≦i≦m being a set of attributes.

Furthermore, an arbitrary order relationship is defined over the set of attributes A, and a system of implications is supplied to the input of the method, from which system of implications a closure operator λ on a set of attributes is deduced using techniques well known to those skilled in the art.

The method according to the invention is based on the Ganter method, but in contrast to the conventional Ganter method, which processes a simple list of attributes, the method according to the invention processes the list S_{A} comprising groups S_{Ai} of attributes. The method according to the invention then executes the following steps:
determine, using the closure operator X, for each group of attributes S_{Ai} of S_{A}, the corresponding closed set of attributes Pᵢ=λ(S_{Ai}); in order to simplify the description, in the following closed sets of attributes will be manipulated, while being aware that, for each of said closed sets, it suffices to apply the function g to said closed set to obtain the corresponding formal concept in the form of a pair (objects, attributes). This step is referenced 102 in FIG. 1;
create a closed set of attributes F initializing them by the closure of the empty set of attributes: F:=λ(Ø);
initialize the set FL of closed sets of attributes arranged in the lexicographic order by adding F to FL: FL={F};
as long as the closed set of attributes F is different from A (step referenced 103 in the figure):
   determine the smallest closed set of attributes B lexicographically greater than F: B=NextClosed(F);
   if B does not exist, terminate the execution of the method;
   otherwise, add B to the set FL and assign B to F;
      At the output of the method in the example, a list FL of closed sets of attributes classified in the lexicographic order is obtained. A list CL of formal concepts classified in the same order can then be generated from the list FL.

The step “B=NextClosed(F)”, allowing the smallest closed set of attributes C lexicographically greater than a set F supplied to the input, is detailed as follows:
create a set of attributes A initializing it to max(P), with P={P₁, P₂, . . . , Pₘ}, Pⱼ being lexicographically smaller than Pₖ for all j and k such that 1≦j≦m−1 and k=j+1;
interpret F as a set of sets of attributes, in other words, F={P_{F1}, P_{F2}, . . . , P_{Fx}, R_{F}} with |F|≦m+1, P_{Fj} for 1≦j≦x being a closed set of attributes belonging to the set P and R_{F} being a residual set comprising attributes not belonging to any of the closed sets of P;
iterate the following steps:
   if the sub-set of attributes A is not included in F:
      modify F as follows: F:=(F∩{A₁, . . . , Aᵢ₋₁})∪{A};
      interpret F as a set of attributes by grouping into a single set F′ all the attributes included in the sub-sets of attributes included in F;
      determine the closed set of F′: B′:=λ(F′), in other words the set of attributes common to all the objects comprising at least the attributes of F′;
      interpret B′ as a set of sets of attributes by partitioning the attributes of B′ to form a set B such that B={P_{B1}, P_{B2}, . . . , P_{By}, R_{B}} with |B|≦m+1, the elements P_{Bj} for 1≦j≦y being closed sets of attributes belonging to the set P, R_{B} being a residual set comprising attributes of B′ not belonging to any of the closed sets of P;
      if B\F does not comprise any element smaller than Aᵢ, return B;
   otherwise, if the sub-set of attributes A is included in F, remove Aᵢ from F: F:=F\Aᵢ;
   if Aᵢ is equal to min(P), then the lexicographically higher closed set of attributes does not exist, end the step NextClosed( );
   otherwise, replace Aᵢ by the set preceding Aᵢ in the list P, in other words by the largest set belonging to P from amongst the sets lexicographically smaller than Aᵢ.

The sets Pᵢ play a role of indivisible elementary building blocks in the formation of the sets of attributes.

In contrast to a conventional Ganter procedure, Aᵢ represents a set of attributes, rather than an attribute, so that the operation “F:=(F∩{A₁, . . . , Aᵢ₋₁})∪{A}” is an intersection between two sets of sets of attributes rather than between sets of attributes.

Since the complexity of the Ganter procedure grows exponentially, the larger the number of attributes at the input, the greater the gain in processing time and in memory usage with respect to a conventional method. For a conventional Ganter method, the processing times and the memory storage space required are, in the worst case scenario, proportional to 2 to the power the number of attributes since the method looks at least once at each closed set of A. On the other hand, the processing times and the memory storage space required by the method according to the invention are, in the worst case scenario, proportional to 2 to the power the cardinal value of P.

Furthermore, according to one embodiment of the method according to the invention, the incompatibility is expressed between several attributes in order to enhance the system of implications supplied to the input of the method. With respect to the conventional methods, a special attribute is added, this attribute henceforth being referred to as “absurd attribute” and denoted as a^{⊥}. The absurd attribute a^{⊥} implies all the attributes:

a^{⊥}→{a₁, . . . aₙ}.

In order to express the incompatibility between the attributes of a sub-set P={a₁, . . . , aₚ}, the following implication is added to the system of implications:

{a₁, . . . , aₚ}→a^{⊥}

The latter implication means that, if an object comprises, for example, two attributes aᵢ and aₖ, 1≦i≦p and 1≦k≦p, then this object does not comprise all the other attributes aₓ of P, 1≦x≦p, x≠i and x≠k. It should be noted that this implication is more restrictive than the following series of implications:

{a₁, a₂}→a^{⊥}, {a₁, a₃}→a^{⊥}, . . . {a₁, aₚ}→a^{⊥};

{a₂, a₃}→a^{⊥}; . . . ; {a₂, aₚ}→a^{⊥};

. . .

{aₚ₋₁, a₆}→a^{⊥}

which series expresses the incompatibility of all the pairs of attributes of the sub-set P; in other words, if an object comprises an attribute of P, then this object does not comprise any other attribute of P.

According to this embodiment, the list C of sets of attributes, supplied to the input of the method, comprises the singleton composed of the absurd attribute a^{⊥}.

In order to represent the lattice previously generated, a second method is executed with a view to constructing the Hasse diagram. This second method receives at its input the list CL={C₁, C₂, . . . C_{N}} of formal concepts classified in the lexicographic order, in other words classified in the compatible order of the inclusion on the intent of the concepts. This list CL has, for example, been generated by the method in FIG. 1. It is recalled that the intent of a formal concept is equal to the closed set of attributes included by the objects of said concept. Here again, the manipulation of sets of sets of attributes imposes the use of a non-conventional method for generating the Hasse diagram, this method being laid out as follows:

Border={C₁};

for i varying from 2 to N:
Cover:=Ø;
For any concept C belonging to the set Border:
   cc=FindConceptByIntentAbove(intent(C)∩intent(Cᵢ), C);
   Cover:=AddAndKeepMinima(Cover , cc);
upperCover(Cᵢ)=Ø;
For any concept C belonging to the set Cover:
   add the concept C to the set upperCover(Cᵢ);
   remove the concept C from the set Border;
add the set Cᵢ to the set Border.
   When this method has been executed, a lattice in the form of a set “Border” of formal concepts is obtained, each concept being associated with its upper cover “upperCover(Cᵢ)”, so as to be able to represent the lattice in the form of a Hasse diagram. The upper cover upperCover(Cᵢ) is a list of formal concepts whose intent, composed of closed sets of attributes Pᵢ, is included in the intent of the concept Cᵢ.

With respect to a conventional method for constructing a Hasse diagram, the interpretation of the operation “intent(C)∩intent(Cᵢ)” is different. Indeed, this operation is not an intersection between two simple sets of attributes, but between two sets of closed sets of attributes. The result of this intersection is also a set of closed sets of attributes. In order to be usable as an argument of the conventional procedure FindConceptByIntentAbove, the result is transformed into a union of all the sets of attributes contained in the set resulting from the intersection.

The procedure FindConceptByIntentAbove identifies a concept by its intent, interpreted in the conventional sense as a set of attributes, while being aware that this concept is greater than or equal to a given concept at the input. The procedure AddAndKeepMinima only conserves, within a list of formal concepts, the concepts whose intent is included in the intent of a concept supplied to the input. The procedures FindConceptByIntentAbove and AddAndKeepMinima are conventional procedures which are recalled hereinbelow in the Appendices.

FIG. 2a shows a lattice obtained with a conventional method.

As a first step, the following set A of attributes is considered:

A={a₁, a₂, a₃, a₄, a₅, a₆, a₇, a^{⊥}}

where a^{⊥} denotes the absurd attribute. Furthermore, the following system of implications is considered:

{a₁, a₂}→{a₃, a₄}

{a₅}→{a₆}

{a₄, a₅}→{a^{⊥}}

{a₃, a₄, a₇}→{a₂}

{a^{⊥}}→{a₁, a₂, a₃, a₄ a₅, a₆, a₇}.

On the basis of this set of attributes and this system of implications, a conventional method results in a closure operator which generates a lattice 201, illustrated in FIG. 2a, comprising 61 nodes.

FIG. 2b shows a lattice obtained with a method according to the invention. If only the following sub-sets of attributes are considered:

A1={a₂, a₅, a₆}

A2={a₃, a₅}

A3={a₄, a₇},

using these sub-sets of attributes A1, A2, A3 and from the aforementioned system of implications, the method according to the invention allows the “useful” lattice 202 illustrated in FIG. 2b to be obtained, a lattice which is significantly less complex than the lattice in FIG. 2a, since it comprises only 6 nodes, shown in the figure as rectangles.

Aside from the saving in processing resources and/or memory obtained when the objects are classified, one advantage of the method according to the invention is that, owing to the prior selection made by virtue of the formation of groups of attributes, it allows the construction of the lattice to be centered around objects that the user wishes to classify, and thus a more readable Hasse diagram to be obtained, since it is not congested with other objects of no interest to the user.

The gains in resources due to the method according to the invention are particularly noteworthy when the taxonomies of the objects to be studied are very extensive. Moreover, the method may be applied in a multitude of fields, such as botanical or molecular taxonomy, to structure the database of a geographical information system, of a surveillance system, of a financial analysis system, or more generally for structuring databases of information gathering and management systems.

### APPENDICES

### Procedure LinClosure:

### Inputs:

set of attributes, denoted M;
a list of implications on M, list denoted L;
a sub-set of M whose closure it is desired to calculated, sub-set denoted X;

### Output:

the closure of X with respect to L, denoted L(X)

```
------- start procedure -------------------------------------
for all x ε M do:
    avoid[x] = {L₁, L₂, ... Lₙ};
    for all y ε {L₁, L₂, ... Lₙ} do
      if x ε sufficient_condition(y), then remove y from avoid[x];
    end for all y
end for all x
usedlmps = ;
oldClosure = ;
newClosure = X;
while (oldClosure ≠ newClosure)
  oldClosure:= newClosure;
  T = M \ newClosure;
  useablelmp = ∩_{xεT} { avoid[x] };
  ulmp:= useablelmp \ usedlmp;
  usedlmp:= useablelmp;
  for all i ε ulmp
      newClosure:= newClosure ∪ conclusion(i);
  end for all
end while
L(X):= newClosure;
------- end procedure -----------------------------------------
```

### Procedure FindConceptByIntentAbove:

### Inputs:

the lattice of concepts being generated, indicating for each concept its upper cover, denoted “upperCover”, which has been calculated by the second method (Hasse diagram);
the set of attributes, denoted inputIntent, whose corresponding concept is sought;
a formal concept, denoted inputConcept, starting from which the search is carried out.

### Output:

the formal concept, denoted curConcept, whose intent is equal to InputIntent

```
------- start procedure -------------------------------------
curConcept:=inputConcept
while (intent(curConcept) ≠ inputIntent)
  up:= false
  for all formal concept c ε upperCover(curConcept)
    if (inputIntent [symbol]  intent(c))
      up:= true;
      curConcept:= c;
      quit loop “for all formal concept c”
    end if
  end for all c
  if up is false, return an error
end while
return curConcept
------- end procedure -----------------------------------------
```

### Procedure AddAndKeepMinima:

### Input:

the order relationship in the lattice of concepts, denoted
a set of concepts for the lattice, denoted InCset;
one concept for the lattice, denoted InC.

### Output:

the set of formal concepts InCset without the formal concepts greater than the formal concept InC

```
-------start procedure-------------------------------------
for all formal concept c ε inCset
  if (c ≦_{L} inC), do not modify the set inCset
  if (inC < _{L} c), remove c from the set inCset
end for all
inCset:= inCset ∪ {inC}
------- end procedure -----------------------------------------
```

1. A method of structuring a database of objects each comprising one or more attributes, the attributes being ordered, the method being executed by at least one processing unit associated with a memory, the method classifying the objects in memory in a structure composed of an ordered list CL of useful formal concepts Cᵢ, comprising at least the following steps:
creating several groups of attributes S_{Ai}, each of said groups bringing together several attributes chosen from amongst the existing attributes;
for each of said groups S_{Ai}, constructing a closed set Pᵢ resulting from the application of a closure operator on S_{Ai};
from the previously created closed sets of attributes Pᵢ determining the list CL of useful formal concepts Cᵢ ordered in the lexicographic order, which order is obtained based on their intent, the intent F of a formal concept Cᵢ being formed by a set of closed sets Pᵢ.

2. The method of structuring a database as claimed in claim 1, further comprising classifying the objects in a structured memory forming a Galois lattice, the method constructing a list Border of formal concepts each corresponding to a node of the lattice, wherein the method associates with the concept Cᵢ of a node of the lattice a list upperCover(Ci) of formal concepts whose intent, composed of closed sets of attributes Pᵢ, is included within the intent of the concept Cᵢ.

3. The method of structuring as claimed in claim 1, one or more data values specifying implications of attributes being supplied to the input of the method, each attribute implication data value comprising a first set of attributes and a second set of attributes, the presence of the attributes of the first set in an object implying the presence of the attributes of the second set in said object, the implication data being used for determining the closed sets of attributes Pᵢ starting from the groups of attributes S_{Ai}, wherein at least one implication data value comprises, in the second set of attributes, a distinctive attribute a^{⊥}, said attribute being necessarily absent from all the objects, in such a manner that said implication data value specifies attributes that are incompatible with one another, the presence of an attribute of the first set in an object implying the simultaneous absence of all the other attributes of this first set in said object.

4. An operational information system implementing the method as claimed in claim 1 for classifying tactical entities by said system.
